(19) United States
(12) Patent Application Publication
(10) Pub. No.: US 2013/0269666 A1
(43) Pub. Date: Oct. 17, 2013

(54) COMBUSTION CHAMBER INSERTS AND ASSOCIATED METHODS OF USE AND MANUFACTURE

(71) Applicant: McAlister Technologies, LLC, (US)

(72) Inventor: Roy Edward McAlister, Phoenix, AZ (US)

(21) Appl. No.: 13/767,835

(22) Filed: Feb. 14, 2013

Related U.S. Application Data
(63) Continuation-in-part of application No. 13/584,753, filed on Aug. 13, 2012.
(60) Provisional application No. 61/523,275, filed on Aug. 12, 2011.

(51) Int. Cl. F02F 1/00

(52) U.S. Cl. CPC F02F 1/004
USPC 123/668

(57) ABSTRACT

Combustion chamber inserts and associated methods of use and manufacture are disclosed herein. In some embodiments, a combustion chamber assembly comprises a cylinder having a cylinder wall at least partially defining a combustion chamber, an intake valve, an exhaust valve, and a piston. The intake valve has an intake valve surface exposed to the combustion chamber, the exhaust valve has an exhaust valve surface exposed to the combustion chamber, and the piston has a piston surface exposed to the combustion chamber. At least one of the cylinder wall, the intake valve surface, the exhaust valve surface, and/or the piston surface includes an insulative portion composed of a synthetic matrix characterization of crystals that is configured to retain heat in the combustion chamber that is generated from a combustion event in the combustion chamber.

### CROSS-REFERENCE TO RELATED APPLICATION(S)

The present application is a continuation-in-part of U.S. patent application Ser. No. 13/584,753, filed Aug. 13, 2012, which claims the benefit of and priority to U.S. Provisional Application No. 61/523,275, filed Aug. 12, 2011, the disclosures of which are hereby incorporated by reference in their entireties.

### TECHNICAL FIELD

The following disclosure relates generally to combustion chamber inserts and, more specifically, to combustion chamber inserts having heat blocking, heat retaining, heat transferring, and/or insulative properties.

### BACKGROUND

Internal combustion systems include combustion of a fuel with an oxidizer in a combustion chamber. The hot gases produced by the combustion event occupy a greater volume than the original fuel and create an increase in pressure within the limited volume of the chamber. This pressure can be used to do work (e.g., move a piston), generating useful mechanical energy. Internal combustion systems are generally most efficient when there is more complete fuel burning at higher temperatures in the chamber. However, combustion chamber liners or coatings designed to improve wear-resistance often increase thermal conduction of the heat outside the combustion chamber. Accordingly, there exists a need for mechanisms to improve combustion efficiency.

### BRIEF DESCRIPTION OF THE DRAWINGS

FIG. 1 is a schematic cross-sectional side view of a combustion chamber assembly configured in accordance with an embodiment of the disclosure.

FIG. 2 is a schematic cross-sectional side view of a combustion chamber assembly configured in accordance with another embodiment of the disclosure.

FIG. 3 is a schematic cross-sectional side view of a combustion chamber assembly configured in accordance with another embodiment of the disclosure.

FIG. 4A is a schematic top plan view of a cylinder head gasket in accordance with an embodiment of the disclosure.

FIG. 4B is a schematic end view of the cylinder head gasket shown in FIG. 4A.

FIG. 5 is a schematic partial top plan view of a cylinder head gasket in accordance with another embodiment of the disclosure.

FIG. 6A is a schematic top plan view of a piston in accordance with an embodiment of the disclosure.

FIG. 6B is a schematic cross-sectional side view of the piston shown in FIG. 6A.

FIG. 7A is a schematic top plan view of a piston in accordance with another embodiment of the disclosure.

FIG. 7B is a schematic cross-sectional side view of the piston shown in FIG. 7A.

FIG. 8A is a schematic top plan view of a piston in accordance with a further embodiment of the disclosure.

FIG. 8B is a schematic cross-sectional side view of the piston shown in FIG. 8A.

FIG. 9A is a schematic top plan view of a piston in accordance with yet another embodiment of the disclosure.

FIG. 9B is a schematic cross-sectional side view of the piston shown in FIG. 9A.

### DETAILED DESCRIPTION

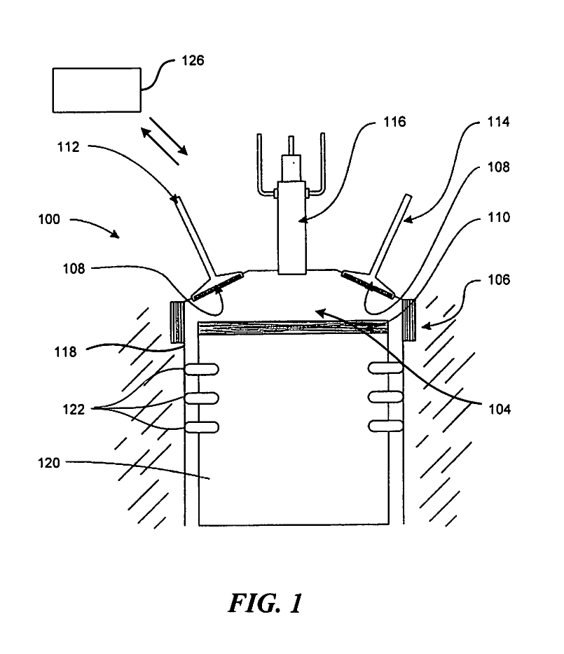

The present disclosure describes devices for providing combustion chamber assemblies with inserts for receiving, retaining, transferring, and/or insulating heat in a combustion chamber. The disclosure further describes associated systems, assemblies, components, and methods regarding the same. Certain details are set forth in the following description and in FIGS. 1-3 to provide a thorough understanding of various embodiments of the disclosure. However, other details describing well-known structures and systems often associated with internal combustion engines, combustion chambers, cylinder heads, cylinder sleeves and/or blocks, gaskets, pistons, injectors, igniters, and/or other aspects of combustion systems are not set forth below to avoid unnecessarily obscuring the description of various embodiments of the disclosure. Thus, it will be appreciated that several of the details set forth below are provided to describe the following embodiments in a manner sufficient to enable a person skilled in the relevant art to make and use the disclosed embodiments. Several of the details and advantages described below, however, may not be necessary to practice certain embodiments of the disclosure.

FIG. 1 is a schematic cross-sectional side view of a combustion chamber assembly 100 configured in accordance with an embodiment of the disclosure. As will be described in further detail below, the combustion chamber assembly 100 can include one or more heat-retaining portions, or inserts, capable of directional heat transfer. The inserts can have an insulative property for blocking heat from traveling in a first direction (e.g., to other parts of the engine), and can have efficient heat transfer properties for facilitating heat transfer or temporarily holding heat and then transferring heat in a second direction (e.g., downstream to facilitate a phase transition of exhaust products).

In the illustrated embodiment, the combustion chamber assembly 100 includes a combustion chamber 104 at least partially defined by an engine cylinder wall 118. An injector 116 is configured to provide fuel and/or coolant injection to the combustion chamber 104. In some embodiments, the injector 116 is a fuel-injector/igniter having features such as those described in U.S. patent application Ser. No. 13/027,051, titled, “FUEL INJECTOR ASSEMBLIES HAVING ACOUSTICAL FORCE MODIFIERS AND ASSOCIATED METHODS OF USE AND MANUFACTURE,” filed Feb. 14, 2011, and incorporated herein by reference in its entirety.

The combustion chamber assembly 100 can further include one or more intake valves 112 and one or more exhaust valves 114 that allow fluid (e.g., air) flow into and out of the combustion chamber 104, respectively. The intake and exhaust valves 112, 114 can be movable between open and closed positions relative to the cylinder wall 118 and can have surfaces exposed to the combustion chamber 104. The combustion chamber assembly 100 can further include an energy transfer device, such as a piston 120, movable relative to the cylinder wall 118. In some embodiments, the piston 120 can be a composite piston such as may be made of internally-reinforced material, such as ceramic, carbon-carbon composite, silicon carbide, silicon carbide fiber compact, and/or nano-spaced arrays of laminar graphite or boron nitride. The piston 120 can be annularly surrounded by piston rings 122 configured to inhibit pressurized fluid from escaping the combustion chamber 104 via space between the piston 120 and the cylinder wall 118. The piston 120 can have one or more surfaces exposed to the combustion chamber 104.

The combustion chamber assembly 100 can further include a sensor and/or transmitting component for detecting and relaying combustion chamber properties and events such as temperatures and pressure and providing feedback to the controller 126. The sensor can be integral to the intake valve 112, exhaust valve 114, injector 116, or other components of the combustion chamber assembly 104 such as component 106. In some embodiments, for example, the sensor can include optical instrumentation, such as infrared temperature monitoring components in the fuel injector 116, and/or a suitable thermistors or thermocouples that monitor the combustion chamber or exhaust temperature. Combustion data can be transmitted via wireless, wired, optical, or other transmission mediums to the controller 126 or other components. Such feedback enables extremely rapid and adaptive adjustments for desired fuel injection factors and characteristics including, for example, fuel delivery pressure, fuel injection initiation timing, combustion chamber pressure and/or temperature, the timing of one, multiple or continuous plasma ignitions or capacitive discharges, etc. For example, the sensor can provide feedback to the controller 126 as to whether the measurable conditions within the combustion chamber 104, such as temperature or pressure, fall within ranges that have been predetermined to provide desired combustion efficiency. Upon combustion chamber components reaching the desired temperature, one or more cooling and work producing cycles are performed as may be indicated by the sensors.

As described above, the combustion chamber assembly 100 can include one or more inserts that can receive, retain, and/or transfer heat from heat producing events such as compression of gases and combustion along with heat transfer events such as swirl, turbulence, and radiation that would otherwise be wastefully dissipated from the combustion chamber 104. Heat can be transferred to and from solid material or material that performs one or more phase changes to improve heat blocking, retention, and return to fluids in the combustion chamber. Materials that perform such phase changes include types that reversibly perform solid-solid, solid-liquid, crystal-amorphus, liquid-liquid and liquid-gas phase changes and may be contained in various amounts and orientations to enhance heat transfer and recovery operations. Suitable substance selections include carious eutectics, eutectoids, NaF—ZrF4 solutions, polymers such as selected olefins, liquid crystals, and halogenated olefins along with substances disclosed in U.S. Pat. No. 5,709,914, the disclosure of which is incorporated herein by reference in its entirety, and other materials that may be selected by persons skilled in the art.

In the illustrated embodiment, the combustion chamber assembly 100 includes valve inserts 108 on the intake valve 112 and/or the exhaust valve 114. A piston insert 110 is coupled to a surface of the piston 120 facing the combustion chamber 104. The combustion chamber assembly 100 further includes a cylinder insert 106 on the cylinder wall 118. The valve inserts 108, the piston insert 110, and the cylinder insert 106 (referred to collectively as “inserts”) can be integral to the combustion chamber assembly 100 or can be separate components coupled to the assembly 100. If the inserts are separate components, they can be attached to the combustion chamber assembly 100 by glue, solder, braze, screws, latches, or other attachment mechanisms. In embodiments in which the inserts are an integral portion of the combustion chamber assembly 100, the inserts can comprise a coating that is applied to combustion chamber assembly 100 components that are exposed to heat from combustion.

In various embodiments, the inserts can include the following materials: boron nitride, aluminum nitride, silicon nitride, graphite, graphene, carbon, beryllia, magnesium oxide, aluminum oxide, spinel, aluminum boride, silica, an architectural construct, combinations of these materials, or other materials having similarly suitable thermal properties as may be produced and tailored from abundant resources such as carbon, silicon, boron, nitrogen, oxygen, aluminum, magnesium, zirconium, and titanium. In some embodiments, the coating material can include architectural construct, as described in U.S. patent application Ser. No. 13/027,214 titled, “ARCHITECTURAL CONSTRUCT HAVING FOR EXAMPLE A PLURALITY OF ARCHITECTURAL CRYSTALS,” filed Feb. 14, 2011, and herein incorporated by reference in its entirety. In some embodiments, the inserts comprise a synthetic matrix characterization of crystals that are configured to retain heat. In several embodiments, the material has a zero, or near-zero, thermal expansion.

Some factors that determine an appropriate material choice include the mass of the material, the specific heat, the latent heat of solidification, the surface to volume ratio, the surface finish/reflectivity, the color, the ability to include fins on the material for increased dimension and surface area, and the types of interaction the material has with flowing fluids, radiation, etc. In certain embodiments, the insert can include parallel, spaced-apart layers of microscopically-thin deposits of various materials chosen for particular thermal properties. For example, the insert can comprise spaced-apart graphite or graphene plates, which provide a low-density material having a relatively high heat-transfer. In further embodiments, the spaced-apart layers can be connected to cooling or heating sources to enhance conduction, radiation, and/or evaporation/condensation by/through the layers.

In some embodiments, the insert can include different materials on different layers or portions of the insert. For example, a material having low thermal conduction could contact a combustion chamber assembly 100 component, such as the cylinder wall 118 or the piston 120, and another material having a high heat capacity could be layered on the first material and could face the combustion chamber 104. In some embodiments, using combinations of multiple materials on the inserts supports multi-phase systems, particularly in large engines with relatively low piston or rotor speeds. For example, the inserts can include thermal shock resistance material such as spinels or can include an architectural construct as a piston insert 110; diamond-coating containing one or more annular rings of sodium, lithium, phosphorus, sulfur, or indium for a cylinder wall insert 106; and eutectoids and eutectics as valve inserts 108.

The insert coating can be applied by various techniques, including, for example, anodizing, diffusion bonding and/or processes that form carbides, borides, and nitrides (e.g., aluminum nitride ion implantation, boron ion implantation), carburizing with boron, carburizing with nitride, carburizing with molybdenum, and/or carburizing with magnesium. In some embodiments, a coating can be applied by hardening the surface of a component of the combustion chamber assembly 100. In some embodiments, the surface can be hardened with a material selected to provide the surface with extended wear capability, reduced starting friction, reduced sliding friction, and/or improved corrosion resistance. The process can further include smoothing at least one surface of the component and applying a treatment to the surface such as ion implantation, chemical vapor deposition, electroplating, electroless plating, sputtering, flame spraying, plasma spraying, diamond-like carbon deposition, magnesiumaluminumboron deposition, nickel deposition, chromium deposition, aluminum deposition, aluminum nitride deposition, and/or titanium boride deposition. In other embodiments, the coatings can be applied using alternate or additional techniques.

In various embodiments, the inserts can be oriented in the combustion chamber assembly 100 to achieve a desired thermal effect. For example, in some embodiments, inserts (e.g., the crystal matrix of the insert material) can be oriented to be transverse to the direction of heat transfer to improve thermal retention. In further embodiments, inserts can have portions oriented at different angles relative to one another. For example, in a particular embodiment, one portion of an insert can insulate the top of the piston 120 while another portion insulates the cylinder wall 118. These portions of the insert can be oriented in different directions relative to one another (and yet both be oriented transverse to heat flow) to provide optimal insulation for the combustion chamber 104. In still further embodiments, a single insert can have layers oriented at nonzero angles relative to one another on the same portion of the insert. For example, an insert insulating the top of the piston 120 can have some layers oriented transversely to the heat transfer direction and other layers oriented obliquely to the heat transfer direction.

In operation, the inserts act as a thermal flywheel, and can provide inertia against temperature fluctuations in the components beneath or that support the inserts in combustion chamber 104. The inserts block, seal, reflect, or otherwise retain heat in the combustion chamber 104 to prevent the heat from conducting away from the combustion chamber 104. Heat that is not conducted and/or reflected into the combustion chamber can be held or retained in thermal flywheel heat transfer portions to be subsequently transferred to work, producing expansive substances during a cooling phase in the combustion chamber and/or in an additional expander. In some embodiments, the inserts can serve to as a thermal flywheels to heat/cool phase change substances. The inserts can be used in conjunction with cooling methods and systems described in U.S. patent application Ser. No. 13/027,170, titled, “METHODS AND SYSTEMS FOR ADAPTIVELY COOLING COMBUSTION CHAMBERS IN ENGINES,” filed Feb. 14, 2011, and herein incorporated by reference in its entirety.

The inserts can also be configured to rapidly give up retained heat during a cooling phase, such as when coolant is injected into the combustion chamber 104 such as during the intake, compression, power and/or exhaust strokes. The amount of energy retained by the inserts, and the ability to retain or release that heat, is determined by the size, placement, shape, and material choice of the inserts. The energy is released to the fluids in the combustion chamber by contact, radiation, or other energy-emission transfer. As described above, sensors in the combustion chamber 104 can provide data to the controller 126, including brake mean effective pressure indicators such as combustion chamber pressure, positive or negative flywheel acceleration, the temperature of the combustion chamber, and/or the temperature of the inserts. The controller 126 can in turn manipulate the combustion chamber 104 conditions, by controlling, for example, the frequency of cooling intake, cooling compression, cooling work, and/or the cooling exhaust cycle in a combustion chamber 104. This sensor/controller 104 interaction thereby determines how much heat is reflected by the inserts and how much is held or retained.

In the illustrated embodiment, the valve inserts 108 face the combustion chamber 104 and have thermal properties that can receive, retain, and/or transfer heat in the combustion chamber 104. The piston insert 110 can block heat transfer to other portions of the piston 120 or combustion chamber assembly 100. The cylinder insert 106 can block heat transfer from the combustion chamber 104 to other zones of the engine assembly. The inserts can together hold the heat of combustion and release it back to the air and fuel and/or the combustion gases in the combustion chamber 104 for the next stroke. In various embodiments, the inserts can be applied to one or more of the piston 120; intake and/or exhaust valves 112, 114; exposed portions of the combustion chamber 104 head; cylinder wall 118; and/or piston rings 122 and/or to the exhaust gas passageways. In further embodiments, the combustion chamber assembly 100 can include more or fewer inserts than illustrated, and the inserts can be located on additional or alternate surfaces of the combustion chamber assembly 100.

The inserts can improve the efficiency of combustion by retaining heat in the combustion chamber 104, increasing fuel-combustion efficiency, and decreasing fuel requirements. The inserts can additionally reduce the demand for general cooling (e.g., a water jacket), as more of the heat generated in the combustion chamber 104 stays in the combustion chamber 104 and does not need to be dissipated. Furthermore, wear on engine parts caused by exposure to conducted heat is reduced, as fewer engine parts are exposed to high-temperature conducted heat from combustion.

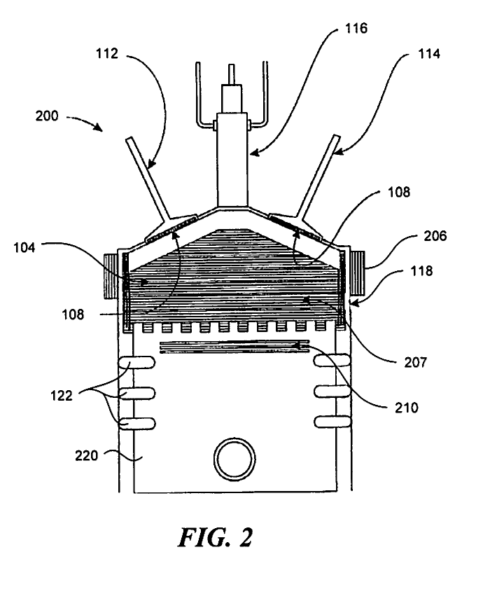

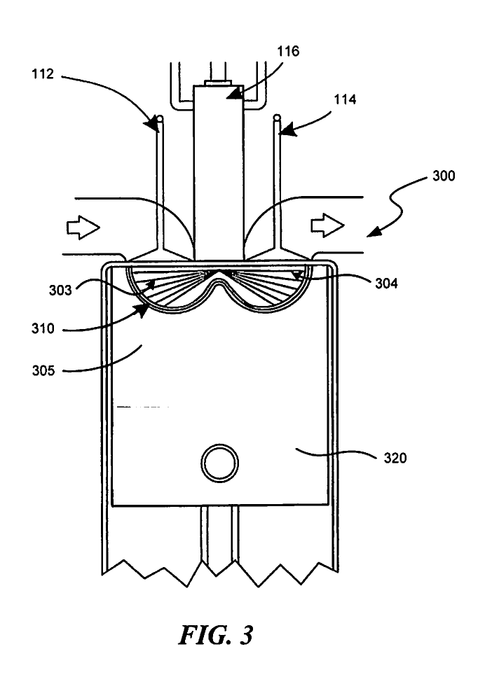

The features of the combustion chamber assembly 100 described above with reference to FIG. 1 can be included in any of the embodiments described below with reference to FIGS. 2 and 3 or in other embodiments of combustion chamber assemblies that have been described in publications that have been incorporated by reference herein. Furthermore, some or all of the features of the combustion chamber assembly 100 can be used with a wide variety of engines including, but not limited to, two-stroke and four-stroke piston engines, rotary combustion engines, gas turbine engines, or combinations of these. The features of the combustion chamber assembly 100 can likewise be used with a wide variety of fuel types including diesel, gasoline, natural gas (including methane, ethane, and propane), renewable fuels (including fuel alcohols—both wet and dry—and nitrogenous fuels such as ammonia), and designer fuels.

FIG. 2 is a schematic cross-sectional side view of a combustion chamber assembly 200 configured in accordance with another embodiment of the disclosure. The combustion chamber assembly 200 includes several features generally similar to the combustion chamber assembly 100 described above with reference to FIG. 1. For example, the combustion chamber assembly 200 includes an injector 116 configured to provide fuel and/or coolant injection to a combustion chamber 104. The combustion chamber 104 is formed from an engine cylinder wall 118, cylinder insert 206, piston 211, piston insert 207, engine head 201, valve 112, valve 114, and valve inserts 108. The combustion chamber assembly 200 can further include the mechanical operating assembly of one or more intake valves 112, one or more exhaust valves 114, and a movable piston 220 annularly surrounded by piston rings 122.

As described above, the combustion chamber assembly 200 can include one or more inserts capable of acting as thermal flywheels to block, reflect, retain, insulate, or transfer heat. For example, in the illustrated embodiment, the combustion chamber assembly 200 includes valve inserts 108 on the intake valve 112 and the exhaust valve 114 facing the combustion chamber 104. The combustion chamber assembly 200 further includes a piston insert 210 attached or incorporated within the piston 220. The positioning of the piston insert 210 thereby inhibits heat from combustion from migrating below the piston insert 210 and the piston rings 122. In further embodiments, the combustion chamber assembly 200 can include additional piston inserts located on other or additional surfaces of the piston 220 and/or in head 201. In operation, the one or more inserts protect the engine by retaining the heat in the combustion chamber rather than allowing it to impacts the engine durability, the insert further directs and reradiates the heat from the combustion event through an exhaust port.

In addition to the valve and piston inserts 108, 210, the combustion chamber assembly 200 further includes a combustion chamber insert 207 that substantially covers an interior surface of the combustion chamber 104. The combustion chamber insert 207 can provide an increased surface area of thermal material to reflect or retain heat in the combustion chamber. A cylinder insert 206 can be attached to the cylinder wall 118 to further retain heat in the combustion chamber 104 and inhibit heat transfer to other parts of the engine. In some embodiments, the combustion chamber insert 207 and cylinder wall insert 206 are oriented at various angles such as offset to one another. In further embodiments, the combustion chamber insert 207 and the cylinder wall insert 206 are oriented at the same angle relative to one another. One or more of the inserts can be aligned in an orientation transverse to the movement of heat from combustion.

FIG. 3 is a schematic cross-sectional side view of a combustion chamber assembly 300 configured in accordance with another embodiment of the disclosure. The combustion chamber assembly 300 includes several features generally similar to the combustion chamber assembly 100 described above with reference to FIG. 1. For example, the combustion chamber assembly includes an injector 116 configured to provide fuel (illustrated by fuel spray lines 303) and/or coolant injection to a combustion chamber 304. The combustion chamber assembly 300 can further include one or more intake valves 112 and one or more exhaust valves 114 that allow fluid flow into and out of the combustion chamber 304, respectively, and a piston 320 movable by a crank shaft and pressure from expanding gas in the combustion chamber 304. In the illustrated embodiment, the piston 320 includes a piston extension 305 attached to the piston 320 and configured to move with the piston 320 and may alter the size and shape of the combustion chamber 304. While the piston extension 305 in the illustrated embodiment includes a double-curved surface facing the combustion chamber 304, other shapes may be used in other embodiments.

The combustion chamber assembly 300 includes a piston insert 310 attached to the piston extension 305. The piston insert 310 lines at least a portion of the curved surface of the piston extension 305 and faces the combustion chamber 304. The piston insert 310 thereby blocks, seals, reflects, or otherwise retains heat in the combustion chamber 304 to prevent the heat from transferring away from the combustion chamber 304 to other zones of the engine assembly. In some embodiments, the piston insert 310 is oriented transverse to the direction of heat flow. In other embodiments, the piston insert 310 can have other orientations or can include layers or portions with different orientations. The piston insert 310 can be used alone or with any of the other inserts described above.

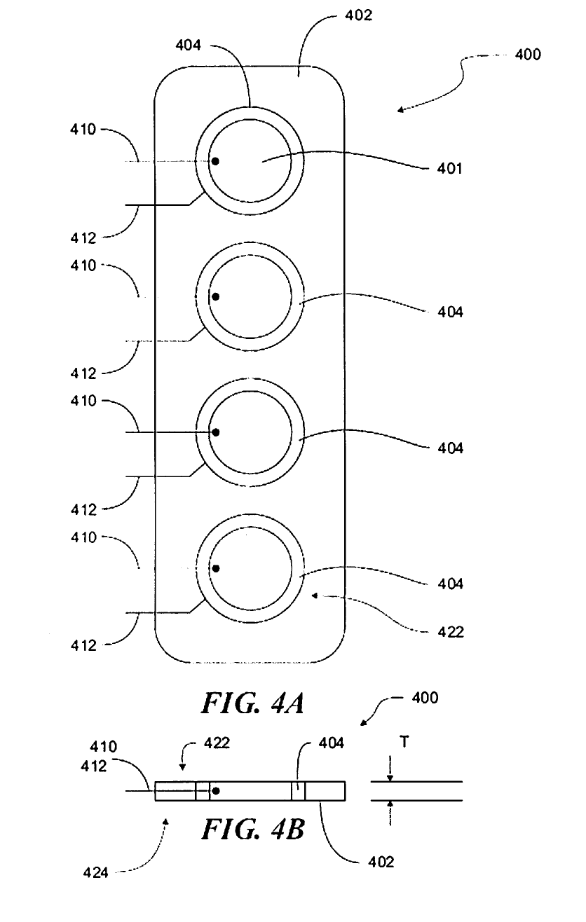

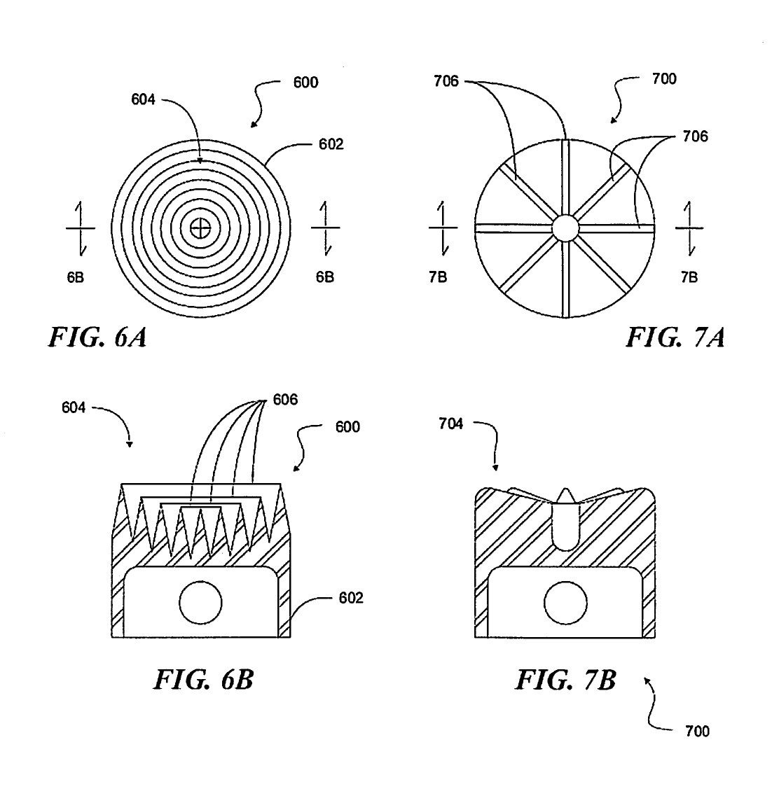

FIGS. 4A and 4B illustrate a cylinder head gasket 400 according to a representative embodiment that incorporates the insert technology disclosed herein. Gasket 400 includes a first sealing surface 422 and a second sealing surface 424 opposite the first sealing surface. An insulative portion extends between the first and second sealing surfaces, wherein the insulative portion comprises a synthetic matrix characterization of crystals that is configured to control heat transfer in the combustion chamber, such as chamber 401. In this embodiment, gasket 400 includes a periphery portion 402 supporting a plurality of insert rings 404, each corresponding to a cylinder of a combustion engine. Thus, each insert ring 404 includes first and second sealing surfaces with an insulative portion extending therebetween. In representative embodiments, the insulative portion (e.g., insert ring 404) may be comprised of a high thermal diffusivity barrier material, such as, for example and without limitation, plasma coated heat blocking ceramic, cermet, and super alloy films, as well as the materials described above. Gasket 400 has a thickness T which can, in some embodiments, accommodate a piston, such as those described more fully below with respect to FIGS. 6A-9B. In some embodiments, cylinder head gasket 400 may further comprise instrumentation 410, such as temperature and/or pressure sensors, which are well known in the art. In other embodiments, gasket 400 may also include optical instrumentation 412. As shown in FIG. 4B, instrumentation 410 and optical instrumentation 412 may extend between the first and second sealing surfaces 422, 424 of gasket 410 in order to access the combustion chamber.

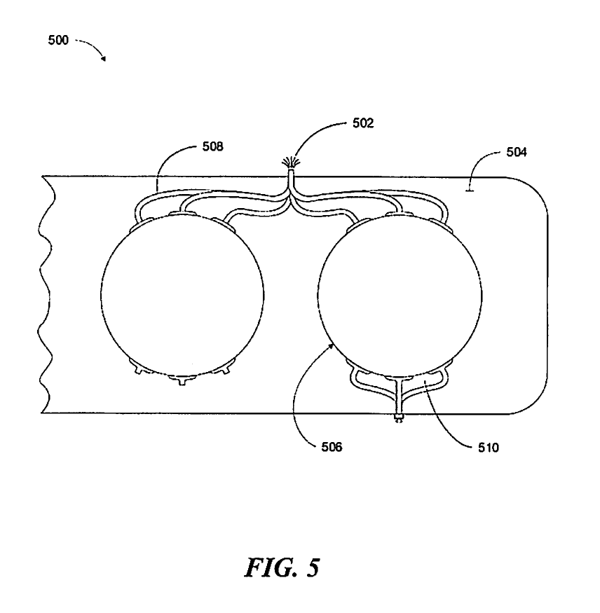

FIG. 5 illustrates a cylinder head gasket 500 according to another representative embodiment that provides sealing of combustion chambers such as 506 and/or other chambers of multi-cylinder engines. Materials such as one or more ceramic fiber paper layers such as silicon carbide fibers bonded by silicon-nitride and/or silicon oxide or other materials, graphite-steel, and carbon-graphite composites are suitable for operation of combustion chamber surfaces at higher temperature and/or with deposit prevention and/or removal thermal cycles. Such materials accommodate integration of devices such as fiber optic or insulated conductor connected instrumentation assemblies 508 for monitoring and measuring the temperature, pressure, fuel injection projections and patterns within the combustion chamber along with component positions and accelerations. Assembly 500 may also incorporate additional components such as fluid dispensing conduits or circuits such as 510 for occasionally administering fluids for cooling, cleaning, or participation in ignition or other combustion events within the combustion chamber.

Illustratively, water and/or other condensates such as may be provided for in stationery engines and/or collected from the exhaust of engines particularly including transportation engines may be occasionally sprayed into the combustion chamber through fluid circuits 510 to produce cooling, cleaning, or boosting of exhaust gas production of work in a subsequent engine such as a turbo expander driving a compressor and/or generator. In some embodiments, circuits 510 provide seepage or pressure sprays of ionized fluid to improve ignition efficiency and may be adaptively utilized in one or more combustion chambers including combustion chambers that are selected for combustion while others are not during requirements for part-load engine operation. Such, systems and methods for improved engine cooling and energy generation are disclosed in co-pending U.S. patent application Ser. No. 13/584,775, filed Aug. 13, 2012, the disclosure of which is incorporated herein by reference in its entirety.

FIGS. 6A and 6B illustrate a piston 600, according to a representative embodiment, that includes a cylindrical piston body 602 and a piston surface 604, which is exposed to a combustion chamber when in operation. The piston surface 604 includes an insulative portion including a synthetic matrix characterization of crystals that is configured to control heat transfer in the combustion chamber. In this embodiment, piston surface 604 includes a topography comprising a series of concentric rings 606 that create a series of peaks and valleys. As shown in the figure, the rings 606 are arranged in a concave configuration. These peaks and valleys increase the surface area of the piston surface 604 and consequently the insulative portion. In addition, the topography of piston surface 604 also creates a transient pressure pattern in the combustion chamber during compression and/or expansion in order to beneficially affect combustion outcome.

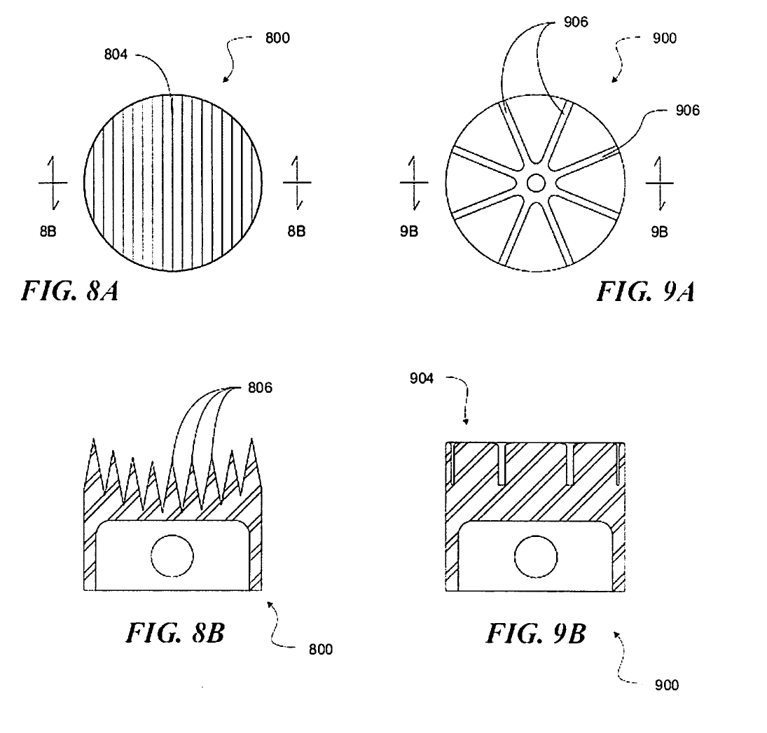

FIGS. 7A and 7B illustrate a piston 700 according to another representative embodiment. Piston 700 is similar to piston 600 described above; however, in this case, piston surface 704 includes a plurality of crossed fins 706, as shown. Again, the topography of piston surface 704 increases the surface area of the piston as well as imparts a pressure pattern in the combustion chamber. FIGS. 8A and 8B illustrate a piston 800 according to a further representative embodiment. Piston 800 is similar to piston 600 described above; however, in this case, piston surface 804 includes a plurality of parallel fins 806, as shown. In a still further embodiment, FIGS. 9A and 9B illustrate a piston 900 that is similar to piston 600 described above; however, in this case, piston surface 904 includes a plurality of crossed grooves 906, as shown.

Also disclosed herein is a combustion chamber insert retrofit kit. In some embodiments, the kit includes a gasket, such as any of those described above, along with at least one piston, such as any of those described above. As disclosed above with respect to FIGS. 4A and 4B, the gasket may have a thickness T that accommodates the piston's insulative portion and/or the topography of the replacement pistons without changing the overall combustion chamber volume. In other embodiments, the gasket thickness is adjusted to change combustion chamber volume and/or compression ratio.

Many of the details, dimensions, angles, shapes, and other features shown in the Figures are merely illustrative of particular embodiments of the disclosure. Accordingly, other embodiments can have other details, dimensions, angles, and features without departing from the spirit or scope of the present disclosure. For example, the embodiments disclosed herein can be used with various types of engines or related systems known in the art. In addition, those of ordinary skill in the art will appreciate that further embodiments of the disclosure can be practiced without several of the details described below.

Reference throughout this specification to “one embodiment” or “an embodiment” means that a particular feature, structure, or characteristic described in connection with the embodiment is included in at least one embodiment of the present disclosure. Thus, the occurrences of the phrases “in one embodiment” or “in an embodiment” in various places throughout this specification are not necessarily all referring to the same embodiment. Furthermore, the particular features, structures, or characteristics may be combined in any suitable manner in one or more embodiments. The headings provided herein are for convenience only and do not interpret the scope or meaning of the claimed disclosure.

It will be apparent that various changes and modifications can be made without departing from the scope of the disclosure. Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number, respectively. When the claims use the word “or” in reference to a list of two or more items, that word covers all of the following interpretations of the word: any of the items in the list, all of the items in the list, and any combination of the items in the list.

Features of the various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the disclosure can be modified, if necessary, to employ combustion chamber assemblies with various configurations, and concepts of the various patents, applications, and publications to provide yet further embodiments of the disclosure.

These and other changes can be made to the disclosure in light of the above detailed description. In general, in the following claims, the terms used should not be construed to limit the disclosure to the specific embodiments disclosed in the specification and the claims, but should be construed to include all systems and methods that operate in accordance with the claims. Accordingly, the invention is not limited by the disclosure, but instead its scope is to be determined broadly by the following claims.

The present application incorporates by reference in their entirety the subject matter of each of the following U.S. Patent Applications:

U.S. patent application Ser. No. 13/027,051, titled, “FUEL INJECTOR ASSEMBLIES HAVING ACOUSTICAL FORCE MODIFIERS AND ASSOCIATED METHODS OF USE AND MANUFACTURE,” filed Feb. 14, 2011; U.S. patent application Ser. No. 13/027,214 titled, “ARCHITECTURAL CONSTRUCT HAVING FOR EXAMPLE A PLURALITY OF ARCHITECTURAL CRYSTALS,” filed Feb. 14, 2011; U.S. patent application Ser. No. 13/027,170, titled, “METHODS AND SYSTEMS FOR ADAPTIVELY COOLING COMBUSTION CHAMBERS IN ENGINES,” filed Feb. 14, 2011.

I/we claim:

1. A cylinder head gasket for sealing a combustion chamber, comprising:
a first sealing surface;
a second sealing surface opposite the first sealing surface; and
an insulative portion extending between the first and second sealing surfaces, wherein the insulative portion comprises a synthetic matrix characterization of crystals that is configured to control heat transfer in the combustion chamber that is generated from a heat producing event in the combustion chamber.

2. The gasket of claim 1 wherein the synthetic matrix characterization of crystals is configured to control heat transfer by providing thermal blocking in a first direction and thermal transfer in a second direction.

3. The gasket of claim 1 wherein the insulative portion includes multiple spaced apart and parallel layers that are oriented generally transversely to a direction of thermal transfer resulting from the combustion event.

4. The gasket of claim 1 wherein the insulative portion includes first spaced apart parallel layers that are oriented at a non-zero angle relative to second spaced apart parallel layers.

5. The gasket of claim 1 wherein the insulative portion is composed primarily of layers of graphene or graphite.

6. The gasket of claim 1 wherein the insulative portion is composed primarily from one of the following: carbon, silicon, boron, nitrogen, oxygen, aluminum, magnesium, zirconium, and titanium.

7. The gasket of claim 1 further comprising instrumentation extending between the first and second sealing surfaces and into the combustion chamber.

8. The gasket of claim 1 further comprising conduits extending between the first and second sealing surfaces to provide fluid flow to or from the combustion chamber.

9. The gasket of claim 8 further comprising phase change material located between the first and second sealing surfaces to provide heat exchange with substances in the combustion chamber.

10. A piston, comprising:
a cylindrical piston body; and
a piston surface exposed to a combustion chamber, wherein the piston surface includes an insulative portion including a synthetic matrix characterization of crystals that is configured to control heat transfer in the combustion chamber that is generated from a heat producing event in the combustion chamber.

11. The piston of claim 10 wherein the insulative portion is a separate insert attached to the piston.

12. The piston of claim 10 wherein the insulative portion is a coating applied piston.

13. The piston of claim 10 wherein the insulative portion includes multiple spaced apart and parallel layers that are oriented generally transversely to a direction of thermal transfer resulting from the heat producing event.

14. The piston of claim 10 wherein the insulative portion includes first spaced apart parallel layers that are oriented at a non-zero angle relative to second spaced apart parallel layers.

15. The piston of claim 10 wherein the insulative portion is composed primarily of layers selected from at least one of graphite, graphene, and a compound of carbon.

16. The piston of claim 10 wherein the insulative portion is composed primarily from one of the following: carbon, silicon, boron, nitrogen, oxygen, aluminum, magnesium, zirconium, and titanium.

17. The piston of claim 10 wherein the piston surface includes topographical features operative to increase the surface area of the piston surface.

18. A combustion chamber insert retrofit kit, comprising:
a cylinder head gasket, comprising:
a first sealing surface;
a second sealing surface spaced a gasket thickness from the first sealing surface; and
an first insulative portion extending between the first and second sealing surfaces, wherein the first insulative portion comprises a synthetic matrix characterization of crystals that is configured to control heat transfer in the combustion chamber that is generated from a heat producing event in the combustion chamber; and
a piston, comprising:
a cylindrical piston body; and
a piston surface exposed to the combustion chamber, wherein the piston surface includes a second insulative portion including a synthetic matrix characterization of crystals that is configured to control heat transfer in the combustion chamber;
wherein the gasket thickness corresponds to a thickness of the second insulative portion.

19. The kit of claim 18 further comprising instrumentation extending between the first and second sealing surfaces to sense events in the combustion chamber.

20. The kit of claim 18 wherein the piston surface includes topographical features operative to increase the surface area of the piston surface.

21. The kit of claim 18 wherein the first and second insulative portions are comprised primarily of layers of substances selected from compositions that include carbon, boron, nitrogen, oxygen, silicon, aluminum, zirconium, magnesium, titanium, graphite, and graphene.

22. The kit of claim 18 wherein the first and second insulative portions are comprised primarily of one of the following: carbon and boron, carbon and silicon, carbon and nitride, boron nitride, aluminum nitride, silicon carbide, and silicon boride.
